(19) United States
(12) Patent Application Publication
(10) Pub. No.: US 2022/0011721 A1
(43) Pub. Date: Jan. 13, 2022

(54) IMAGING METHOD AND DATA GENERATION METHOD FOR HOLOGRAPHIC IMAGE, AND APPARATUS

(71) Applicant: SHANGHAI INTELIGHT ELECTRONIC TECHNOLOGY CO., LTD., Shanghai (CN)

(72) Inventor: Shunyi TAN, SUZHOU (CN)

(21) Appl. No.: 16/618,347

(22) PCT Filed: Mar. 6, 2018
(86) PCT No.: PCT/CN2018/078083

§ 371 Date: Nov. 30, 2019

(30) Foreign Application Priority Data
May 31, 2017 (CN) 201710398583. 1

(51) Int. Cl. G03H 1/08; G03H 1/22; H04N 13/388; H04N 13/122

(52) U.S. Cl. CPC G03H 1/0808; G03H 1/2294; G03H 2210/441; H04N 13/388; H04N 13/122; G03H 1/2202

(57) ABSTRACT

The present invention provides an imaging method for an image, including the following steps: step 1: receiving image data, the image data including an image main data and image characteristic data; and step 10: processing the image main data according to the image characteristic data, generating the holographic image and outputting the holographic image. The present invention provides an imaging method and a data generation method for a holographic image, and an apparatus that include each characteristic element of the holographic image and can further improve the efficiency of each link in storage, transmission and conversion.

### CROSS-REFERENCE TO RELATED APPLICATIONS

This application is a national stage application of PCT Application No. PCT/CN2018/078083. This application claims priority from PCT Application No. PCT/CN2018/078083 filed Mar. 6, 2018, CN Application No. CN 201710398583.1 filed May 31, 2017, the contents of which are incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### FIELD OF TECHNOLOGY

The present invention mainly relates to a holographic image technology, and in particular to a dynamic imaging method and data generation method for a dynamic holographic image, and an apparatus.

### BACKGROUND

A holographic display effect similar to a Three-Dimensional (3D) effect may be implemented by means of multiple images at different distances from an observer. Such an image can keep a distance consistent with an external actual scenery, so that a spectator feels that the image is really attached to an actual object. It has an important significance in augmented display application and the expressiveness gets much beyond a planar image. Therefore, many groups or organizations in medical industry, industrial application, vehicle and riding sports, film producers, and sports program broadcasting companies are always expected to convey a content to the spectator in a manner of a holographic image. On the other hand, the spectator is also looking forward to viewing the holographic image. Along with the advancement of technologies, the implementation of the real-time holographic image via a manner of computer-generated holography has become possible. However, the holographic image includes multiple types of information not possessed by a conventional two-dimensional (2D) image, such as an actual imaging distance of each object, a viewing angle, and a surface-hidden relationship for reflecting mutual block between the objects. At present, a technical solution that well integrates each element possessed by the holographic image, standardizes a whole processing procedure and further can improve the storage and conversion efficiency hasn't been proposed.

For the above defects, it is necessary to provide an imaging method and a data generation method for a holographic image, and an apparatus that can include each element of the holographic image well and can further improve the efficiency of each link in storage, transmission and conversion.

Therefore, a heretofore unaddressed need exists in the art to address the aforementioned deficiencies and inadequacies.

### SUMMARY

A technical problem to be solved by the present invention is to provide an imaging method and a data generation method for a holographic image, and an apparatus that include each characteristic element of the holographic image and can further improve the efficiency of each link in storage, transmission and conversion. In order to solve at least one part of the technical problem of the present invention, the present invention provides an imaging method for a holographic image, including the following steps: step 1: receiving image data, the image data including an image main data and image characteristic data; and step 10: processing the image main data according to the image characteristic data, generating the holographic image and outputting the holographic image.

According to at least one embodiment of the present invention, the image characteristic data includes file characteristic data, frame characteristic data and sub-frame characteristic data, and the imaging method further includes the following steps:

step 2: identifying the image main data or the file characteristic data and the image main data included in the image data;

step 3: separating the image main data into one or more pieces of frame data;

step 4: reading the frame data, and identifying a frame main data or the frame main data and the frame characteristic data of the frame data;

step 5: separating the frame main data into one or more pieces of sub-frame data, reading each piece of sub-frame data, identifying a sub-frame main data and sub-frame characteristic data of the sub-frame data, the sub-frame characteristic data including a first characteristic, and each image element in the sub-frame main data having the same first characteristic, and extracting the first characteristic; and

step 6: processing the sub-frame main data according to the file characteristic data, the frame characteristic data and the sub-frame characteristic data, generating the holographic image and outputting the holographic image, the file characteristic data and the frame characteristic data including a practical content or excluding the practical content.

According to at least one embodiment of the present invention, the step 6 further includes the following steps:

step 6.1: reading each piece of sub-frame data, and identifying sub-frame characteristic data and a sub-frame main data for each piece of sub-frame data;

step 6.2: separating the sub-frame main data into one or more pieces of branched sub-frame data, reading each piece of branched sub-frame data, identifying a branched sub-frame main data and branched sub-frame characteristic data of the branched sub-frame data, each image element in the branched sub-frame data having a same second characteristic; and

step 6.3: generating the holographic image according to the file characteristic data, the frame characteristic data, the sub-frame characteristic data and the branched sub-frame characteristic data and outputting the holographic image.

According to at least one embodiment of the present invention, the image characteristic data includes one or more of an image distance, a receiving object, an image angle, a scaling, a hidden-surface relationship, left and right frames, an image color and light intensity.

According to at least one embodiment of the present invention, the image main data is a bitmap, a vector diagram or a hologram needing to be displayed; and the bitmap, the vector diagram or the hologram are encrypted or unencrypted, and compressed or uncompressed.

According to at least one embodiment of the present invention, the first characteristic is the color, each frame main data is separated into multiple pieces of sub-frame data, and the color of each image element in the sub-frame data is one type in a spectrum; or

the second characteristic is the color, each sub-frame main data is separated into multiple pieces of branched sub-frame data, and the color of each image element in the branched sub-frame data is one type in the spectrum.

According to at least one embodiment of the present invention, the file characteristic data includes frame identification information, the frame identification information includes frame length information representing a length of each piece of frame data, and the image data is separated into multiple pieces of frame data according to the frame length information in the step 3; and/or

the frame characteristic data includes sub-frame identification information, the sub-frame identification information includes sub-frame length information representing a length of each sub-frame, and each frame main data is separated into one or more pieces of sub-frame data according to the sub-frame length information in the step 5.

According to at least one embodiment of the present invention, the sub-frame characteristic data includes branched sub-frame identification information, the branched sub-frame identification information includes branched sub-frame length information representing a length of each branched sub-frame, and each sub-frame main data is separated into one or more pieces of branched sub-frame data according to the branched sub-frame length information in the step 6.1.

According to at least one embodiment of the present invention, the file characteristic data includes frame identification information, the frame identification information includes a frame end field, an end of each piece of frame data has the frame end field, and the image data is separated into one or more pieces of frame data according to the frame end field in the step 3; and/or

the frame characteristic data includes sub-frame identification information, the sub-frame identification information includes a sub-frame end field, an end of each sub-frame has the sub-frame end field, and each frame main data is separated into one or more pieces of sub-frame data according to the sub-frame end field in the step 5.

According to at least one embodiment of the present invention, the sub-frame characteristic data includes branched sub-frame identification information, the branched sub-frame identification information includes a branched sub-frame end field, an end of each branched sub-frame has the branched sub-frame end field, and each sub-frame main data is separated into multiple pieces of branched sub-frame data according to the branched sub-frame end field in the step 6.1.

According to at least one embodiment of the present invention, the imaging method provided by the present invention further includes the following steps: step 3.1: identifying that the file characteristic data further includes left-right frame information, the left-right frame information representing that the frame data in the image main data belongs to left frame data or right frame data; and

step 10.1: projecting a sub-frame or a branched sub-frame of a frame belonging to a corresponding left frame to a left eye of a user, and projecting the sub-frame or the branched sub-frame of the frame belonging to a right frame to a right eye of the user.

According to at least one embodiment of the present invention, the method for processing the image main data, the frame main data and the sub-frame main data is to generate a corresponding phase distribution according to the file characteristic data, the frame characteristic data or the sub-frame characteristic data.

According to at least one embodiment of the present invention, the phase distribution is loaded to the image main data, the frame main data and/or the sub-frame main data and/or the branched sub-frame main data, and the integrated image data, frame data and/or sub-frame data and/or branched sub-frame data are output.

According to at least one embodiment of the present invention, the imaging method provided by the present invention further includes the following step: step 3.2: identifying compensation information in the image data, the compensation information including one or more of a defocusing coefficient, a spherical aberration coefficient, a comatic aberration coefficient, an astigmatic coefficient, a distortion coefficient, a field curvature coefficient, a lateral chromatic aberration, a position aberration and a higher order aberration.

According to at least one embodiment of the present invention, the imaging method provided by the present invention further includes the following steps: step 3.3: identifying angle information in the frame characteristic data; and

step 6.3: rotating frame or sub-frame or branched sub-frame data belonging to same frame data according to an angle corresponding to the angle information in the frame characteristic data, and outputting the rotated frame or sub-frame or branched sub-frame data.

According to at least one embodiment of the present invention, the imaging method provided by the present invention further includes the following steps: step 3.4: identifying relevant information included in the file characteristic data, the relevant information including one or more of the image data length information, the compensation information, temperature information, brightness information, bit depth information, resolution information, play speed information, single frame data format information, frame characteristic data length information, whether to compress and a compression manner, creation time information, whether to encrypt and encryption manner information; and

step 6.4: adjusting the sub-frame or branched sub-frame data according to the relevant information.

According to at least one embodiment of the present invention, the imaging method provided by the present invention further includes the following steps: step 6.5: reading light intensity information in frame characteristic data or sub-frame characteristic data or branched sub-frame characteristic data; and

when displaying the frame data or the sub-frame data or the branched sub-frame data, sending the light intensity information to a light source drive or a light source, and sending the hologram generated after the processing of the frame or sub-frame main data or branched sub-frame main data to a spatial light modulator.

According to at least one embodiment of the present invention, at least one part of the characteristic data is directly converted into the phase distribution to output to the spatial light modulator.

According to at least one embodiment of the present invention, the image data at least includes a piece of subordinated frame/sub-frame/branched sub-frame data, and the subordinated frame/sub-frame/branched sub-frame data only includes difference information between the subordinated frame/sub-frame/branched sub-frame data and a previous piece of frame/sub-frame/branched sub-frame data of the subordinated frame/sub-frame/branched sub-frame data; and

when displaying the subordinated frame/sub-frame/branched sub-frame data, taking a combination of frame/sub-frame/branched sub-frame data of the previous piece of frame/sub-frame/branched sub-frame data and frame/sub-frame/branched sub-frame data of the subordinated frame/sub-frame/branched sub-frame data as the subordinated frame/sub-frame/branched sub-frame data.

According to at least one embodiment of the present invention, the step 1 and/or the step 2 are completed at a server, and the server sends a result to one or more clients.

According to at least one embodiment of the present invention, the steps 1-6 are completed at the server, and the server sends the result to one or more clients.

According to at least one embodiment of the present invention, the client sends at least one part of the file characteristic data and/or the frame characteristic data to the server; and/or

the client sends the sever the instruction information of the requirements of generating the image data.

According to at least one embodiment of the present invention, at least one step in the steps 1-6 is completed at the client, and the rest are completed at the server; and

the server sends the result to one or more clients.

According to at least one embodiment of the present invention, the imaging method provided by the present invention further includes the following steps: step 1.1: sending, by the client, a video file to the server; and/or

step 1.2: sending, by the client, a play scenario parameter to the server; and

step 6.5: optimizing, by the server, the frame data or the sub-frame data or the branched sub-frame data according to the play scenario parameter, and sending an optimized hologram generated by the frame data or the sub-frame data or the branched sub-frame data to the client, the play scenario parameter including one or more of display size, resolution, a distance between an image and a user, a viewing angle, environment light intensity, surface-hidden information, color information, the compensation information, the scaling, the receiving object, and the left and right frames.

According to at least one embodiment of the present invention, the server is connected to the client via a wireless or wired manner.

According to at least one embodiment of the present invention, the wireless connection is one or more of Bluetooth, Wireless Fidelity (Wi-Fi), 3rd-Generation (3G), 4th-Generation (4G) and 5th-Generation (5G).

According to at least one embodiment of the present invention, upon the determination that a last piece of frame data of the image data is displayed completely and no subsequent input is provided, the current frame data is displayed cyclically.

According to at least one embodiment of the present invention, the holographic image output by the step 6 is cached and then output to the spatial light modulator in a color cyclic arrangement manner.

According to at least one embodiment of the present invention, the method for processing the image main data according to the file characteristic data includes the following steps:

step a: inputting an energy distribution of a target image, the preset superimposed number of holographic sub-frames and a preset iteration condition, or the energy distribution of the target image, the preset superimposed number of holographic sub-frames and the preset iteration condition as well as at least one of an imaging distance, an imaging angle and the compensation information;

step b: calculating intensity and phase distribution of a frame/sub-frame/branched sub-frame image needing to be displayed;

step c: calculating a hologram or a hologram sub-frame or a hologram branched sub-frame;

step d: determining whether the iteration condition is met; if yes, operating the step e; and

if no, skipping to the step g;

step e: calculating a quantized hologram frame or a quantized hologram sub-frame or a quantized hologram branched sub-frame;

step f: calculating new intensity and phase distribution according to an image corresponding to the quantized hologram frame or the quantized hologram sub-frame or the quantized hologram branched sub-frame and/or intensity and/or phase distribution and/or compensation information of a frame/sub-frame/branched sub-frame image needing to be displayed, and skipping back to the step c, or changing the iteration condition or parameter and skipping back to the step c;

step g: outputting a corresponding quantized hologram frame/sub-frame/branched sub-frame of a corresponding frame/sub-frame/branched sub-frame;

step h: supposing to accumulate the superimposed number of hologram sub-frames/branched sub-frames, and resetting the iteration condition;

step i: determining whether the superimposed number of hologram sub-frames/branched sub-frames reaches to a preset value; if no, operating the step j; and if yes, ending the calculation of the frame or sub-frame image, and waiting for or accepting a next frame or sub-frame image; and

step j: changing the intensity and/or phase distribution or corresponding parameter of the frame/sub-frame/branched sub-frame image, and skipping to the step b.

In order to solve at least one part of the technical problem of the present invention, the present invention further provides an image data generation method, including the following steps:

step 101: extracting a characteristic of an image element needing to be displayed, and taking the extracted characteristic as image characteristic data, the characteristic including one or more of an image distance, a receiving object, a scaling, a viewing angle, left and right frames, surface-hidden information, a color, and light intensity;

step 102: separating the characteristic extracted image element into one or more frames according to a time sequence, and taking the one or more frames as an image main data; and

step 130: encapsulating the image main data and the image characteristic data into image data.

According to at least one embodiment of the present invention, the image data generation method provided by the present invention further includes the following step: step 103: writing frame identification information corresponding to a frame data format of to-be-generated frame data to file characteristic data.

According to at least one embodiment of the present invention, the image data generation method provided by the present invention further includes the following steps: step 104: taking the image element having a same first characteristic in each frame as a sub-frame main data of same sub-frame data, and writing the first characteristic to the sub-frame characteristic data, the first characteristic being one or more of the color, the image distance, the receiving object, the viewing angle, the scaling, the left and right frames, a surface-hidden relationship and the light intensity; and

step 105: taking sub-frame data in each frame as a frame main data, and encapsulating the frame main data and the frame characteristic data into the frame data.

According to at least one embodiment of the present invention, the image data generation method provided by the present invention further includes the following step: step 106: writing sub-frame identification information corresponding to a sub-frame data format of to-be-generated sub-frame data to frame characteristic data.

According to at least one embodiment of the present invention, the image data generation method provided by the present invention further includes the following steps: step 106: taking the image element having a same second characteristic as a branched sub-frame main data, and writing the second characteristic to the branched sub-frame characteristic data, the second characteristic is different from the first characteristic and being one or more of the color, the image distance, the receiving object, the viewing angle, the scaling, the left and right frames, the surface-hidden relationship and the light intensity; step 107: encapsulating the branched sub-frame main data and corresponding branched sub-frame characteristic data into one piece of branched sub-frame data;

step 120: taking a branched sub-frame having the same first characteristic in each frame as a sub-frame main data, and encapsulating the sub-frame main data and corresponding sub-frame characteristic data into one piece of sub-frame data; and

step 121: taking sub-frame data in each frame as a frame main data, and encapsulating the frame main data and the frame characteristic data into the frame data.

According to at least one embodiment of the present invention, the image data generation method provided by the present invention further includes the following step: step 108: writing branched sub-frame identification information corresponding to a branched sub-frame data format of to-be-generated sub-frame data to the sub-frame characteristic data, and/or writing sub-frame identification information corresponding to a sub-frame data format of to-be-generated sub-frame data to the frame characteristic data.

According to at least one embodiment of the present invention, at least one of the file characteristic data, the frame characteristic data, the sub-frame characteristic data and the branched sub-frame characteristic data is phase distribution.

According to at least one embodiment of the present invention, a method for converting the file characteristic data, the frame characteristic data, the sub-frame characteristic data or the branched sub-frame characteristic data into the phase distribution is to calculate the phase distribution for the current image characteristic data, frame characteristic data, sub-frame characteristic data or branched sub-frame characteristic data, or invoke the corresponding phase distribution in a preset phase distribution library according to the file characteristic data, the frame characteristic data, the sub-frame characteristic data or the branched sub-frame characteristic data.

According to at least one embodiment of the present invention, the first characteristic is the color, the color of the sub-frame data is written to the sub-frame characteristic data in the step 104, and the color of the image element in the sub-frame data is one of basic parameters in a color space; or

the second characteristic is the color, the same color is written to branched sub-frame characteristic data of the branched sub-frame in the step 104, and the color of each image element in the branched sub-frame data is one of the basic parameters in the color space.

According to at least one embodiment of the present invention, the first characteristic is the image distance, the image distance of the sub-frame is written to the sub-frame characteristic data in the step 104, and the image distance of each image element in the sub-frame data is the same; or

the second characteristic is the image distance, the same image distance is written to branched sub-frame characteristic data of the branched sub-frame in the step 106, and the image distance of each image element in the branched sub-frame data is the same.

According to at least one embodiment of the present invention, the frame identification information, the sub-frame identification information or the branched sub-frame identification information is a length of the frame data, the sub-frame data or the branched sub-frame data.

According to at least one embodiment of the present invention, the frame identification information, the sub-frame identification information or the branched sub-frame identification information is a frame end field on the end of the frame data, a sub-frame end field on the end of the sub-frame data or a branched sub-frame field on the end of the branched sub-frame data.

According to at least one embodiment of the present invention, the image data generation method provided by the present invention further includes the following step: identifying a left frame image element needing to be projected to a left eye of a user and a right frame image element needing to be projected to a right eye of the user in the image element, writing the left frame image element to left frame data, writing the right frame image to right frame data, and writing left-right frame information on whether each piece of frame data is the left frame data or the right frame data to the file characteristic data.

According to at least one embodiment of the present invention, the left frame data and the right frame data are the same in number and are arranged alternately in the image data.

According to at least one embodiment of the present invention, the image data generation method provided by the present invention further includes the following steps: generating compensation information according to device and/or user information, the compensation information including one or more of a spherical aberration coefficient, a comatic aberration coefficient, an astigmatic coefficient, a distortion coefficient, a field curvature coefficient, a lateral chromatic aberration, a position aberration, a higher order aberration, a diopter coefficient and an astigmatic coefficient; and writing the compensation information to the file characteristic data.

According to at least one embodiment of the present invention, the image data generation method provided by the present invention further includes the following step: generating angle information for each frame according to an image needing to be displayed, and writing the angle information for each frame to frame characteristic data of corresponding frame data.

According to at least one embodiment of the present invention, relevant information of the image needing to be displayed is written to the file characteristic data, the relevant information including one or more of the image data length information, the compensation information, temperature information, bit depth information, brightness information, resolution information, play speed information, single frame data format information, frame characteristic data length information, whether to compress and a compression manner, creation time information, whether to encrypt and encryption manner information.

According to at least one embodiment of the present invention, the image data generation method provided by the present invention further includes the following step: taking total light intensity of a branched sub-frame main data in each piece of branched sub-frame data as light intensity information to write to branched sub-frame characteristic data of the branched sub-frame data, and normalizing the branched sub-frame main data to serve as the branched sub-frame main data; or

taking total light intensity of a sub-frame main data in each piece of sub-frame data as light intensity information to write to sub-frame characteristic data of the sub-frame data, and normalizing the sub-frame main data to serve as the sub-frame main data; or

taking total light intensity of a frame main data in each piece of frame data as light intensity information to write to frame characteristic data of the frame data, and normalizing the frame main data to serve as the frame main data.

According to at least one embodiment of the present invention, the image data generation method provided by the present invention further includes the following step: taking at least one unit as a subordinated unit, and taking a difference between the subordinated unit and a previous unit of the subordinated unit as a content of the subordinated unit; and

the unit is the frame data, the sub-frame data, or the branched sub-frame data.

In order to solve at least one part of the technical problem of the present invention, the present invention further provides an apparatus, including: a processor; and the processor enables, when running, the apparatus to at least execute one of the above methods.

In order to solve at least one part of the technical problem of the present invention, the present invention further provides an apparatus, including: a memory, and a processor; the memory includes a computer code stored thereon; and the code is configured to enable, when being run on the processor, the apparatus to at least execute one of the above methods.

In order to solve at least one part of the technical problem of the present invention, the present invention further provides a computer readable medium storing a computer code thereon; and the computer code is configured to execute, when being run on a processor, one of the above methods.

An imaging method, a data generation method and an apparatus provided by the present invention can include each characteristic element of a holographic image and can further improve the efficiency of each link in storage, transmission and conversion.

### BRIEF DESCRIPTION OF THE DRAWINGS

The accompanying drawings illustrate one or more embodiments of the present invention and, together with the written description, serve to explain the principles of the invention. Wherever possible, the same reference numbers are used throughout the drawings to refer to the same or like elements of an embodiment.

FIG. 1 illustrates a flow diagram of an imaging method for a holographic image according to an embodiment of the present invention.

FIG. 2 illustrates a structural schematic diagram of holographic image data according to an embodiment of the present invention.

FIG. 3 illustrates a flow diagram of a data generation method for a holographic image according to an embodiment of the present invention.

FIG. 4 illustrates a schematic diagram of a hardware implementation method of an imaging method for a holographic image according to an embodiment of the present invention.

### DESCRIPTION OF THE EMBODIMENTS

In order to make the above objectives, characteristics and advantages of the present invention more apparent and understandable, the specific embodiments of the present invention will be described below in detail in combination with the accompanying drawings. Many particular details are described in the following description for the ease of a full understanding of the present invention. However, the present invention may further be implemented in other manners different from those described herein. The present invention is not limited by the following specific embodiment of the present invention.

As shown in the description and claims of the present invention, unless an exceptional case is explicitly indicated in a context, “a”, “an”, “one” and/or “the” are not intended to indicate a singular form, and may also include a plural form. Generally, terms “include”, “including”, “comprise” and “comprising” only indicate that only explicitly indicated steps and element are included, and these steps and elements are not formed into an exclusive enumeration; and a method or a device may also include other steps or elements.

First of all, an imaging method for a holographic image provided by the present invention is illustrated with an unrestricted example. The imaging method for the holographic image provided by the present invention includes two steps. The first step is to receive image data of the image. The image data further includes an image main data as a main body of a display content, and image characteristic data not included by the image main data in the main body for describing the display content (independent of the image main data). That is, some common and independent characteristics in the image data are received as the characteristic data, and the rest are received as the image main data. The second step is to process the image main data according to the received image characteristic data, generate the holographic image and output the holographic image.

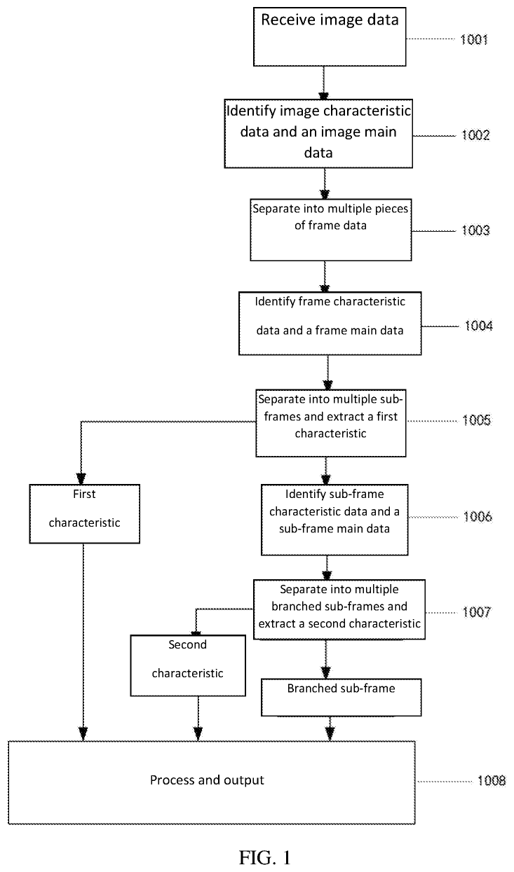

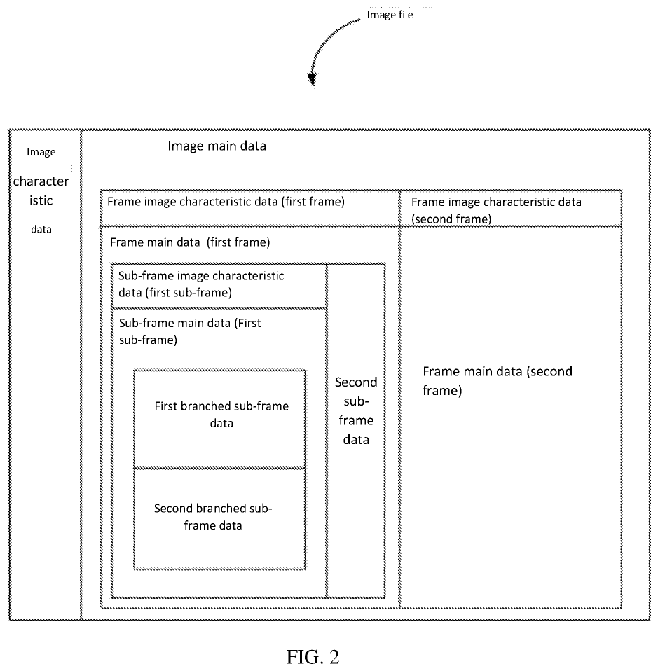

The imaging method for the image provided by the present invention will be further illustrated below with one unrestricted example in conjunction with FIGS. 1-2. In the current unrestricted example, the imaging method for the holographic image includes the following steps:

Step 1001: receive image data including an image content. This step may be implemented at a client. For example, it may be appropriate that a hand-held intelligent device of a user receives data from a network or data generated by a wearable device of the user, etc. In addition, the meaning of “receive” is generalized, for example, image data generated by a single game run in a local personal computer is received. It may also be understood that the personal computer as a display device receives the image data from itself when displaying the holographic image. The image data includes an image main data and image characteristic data. The image characteristic data may be data in which characteristics of the whole image data are included and integrated together, and may also be data in which characteristics representing a part of content in the image are separately arranged in the whole image data. Upon the completion of this step, the image main data may be directly processed according to the image characteristic data, and the holographic image is generated and output. The method may also be skipped to the step 1002.

Step 1002: identify the image characteristic data and the image main data included in the image data. The image characteristic data includes sub-frame characteristic data, file characteristic data and frame characteristic data. Optionally, the file characteristic data is located at a front end of the image data and is prior to the image main data. With such an arrangement, the image data is adapted to be sent in a manner of streaming media. Or the image characteristic data may also be transmitted via a special hardware circuit, so that the characteristic data may be independent of the image main data and both the characteristic data and the image main data are sent at the same time in the manner of streaming media. In addition, it can further be allowable that the image characteristic data only has the sub-frame characteristic data but not the frame characteristic data and/or file characteristic data.

Step 1003: separate the image main data into one or more pieces of frame data. In this step, the image main data may be separated via frame identification information in the file characteristic data into many small pieces of frame data that only includes a content needing to be displayed within a time period. The information in the frame identification information may also be agreed in advance during the design of hardware and/or software and does not need to be written down the frame identification information specially. The image characteristic data does not contain the frame identification information.

It is to be noted that, after this step in some examples, the final step of processing the frame main data according to the frame characteristic data and outputting the frame main data may be executed directly. However, in the current example, the frame main data is subjected to the subsequent step 1004, but instead of directly processing and outputting the frame main data. In addition, it can further be allowable that the image characteristic data only has the sub-frame characteristic data and file characteristic data but not the frame characteristic data.

Step 1004: read each piece of frame data, and identify frame characteristic data and frame main data for each piece of frame data. This step may be similar to the method in the step 1002.

Step 1005: first separate the frame main data into one or more pieces of sub-frame data, and read each piece of sub-frame data. The method for separating the frame main data into the sub-frame may be, for example, to separate each frame main data into one or more pieces of sub-frame data according to sub-frame identification information in the frame characteristic data. For the separated sub-frame, a sub-frame main data and sub-frame characteristic data for each piece of sub-frame data are identified, where the sub-frame characteristic data includes a first characteristic, and each image element in the sub-frame main data has the same first characteristic; and the first characteristic is extracted. Herein, the first characteristic is a combination of one or more of a color, an image distance, a receiving object, a scaling, a viewing angle, light intensity, surface-hidden information, and left and right frames. It is to be noted that the “color” also has a generalized understanding, may be understood as red, yellow and blue colors in a Red Green Blue (RGB) color space, and may also be understood as hue, saturation and brightness in a Hue-Saturation-Brightness (HSB) color space. Additionally, the information in the sub-frame identification information may also be agreed in advance during the design of hardware and/or software. Herein, the sub-frame data may not have the sub-frame identification information and the first characteristic and the sub-frame main data are identified directly.

Upon the completion of the current step, the sub-frame main data may be processed according to the sub-frame characteristic data, or at least one of the sub-frame characteristic data, the file characteristic data and the frame characteristic data, and the holographic image is generated and output. The method may also be skipped to the step 1006. Besides, the file characteristic data and the frame characteristic data include a practical content or not include the practical content. That is, when both the file characteristic data and the frame characteristic data not include the practical content, the file characteristic data and the frame characteristic data may only include a form content and may also be completely inexistent, and the sub-frame main data is only processed according to the sub-frame characteristic data in imaging.

Step 1006: read each piece of sub-frame data, and identify sub-frame characteristic data and a sub-frame main data for each piece of sub-frame data.

Step 1007: separate the sub-frame main data into one or more pieces of branched sub-frame data, read each piece of branched sub-frame data, and identify a branched sub-frame main data and branched sub-frame characteristic data of the branched sub-frame data, where each image element in the branched sub-frame data has a same second characteristic, and the second characteristic is another combination of one or more of the color, the image distance, the receiving object, the scaling, the viewing angle, the surface-hidden information, the light intensity, and the left and right frames; and then, extract the second characteristic. Additionally, the information in the branched sub-frame identification information may also be agreed in advance during the design of hardware and/or software. Herein, the branched sub-frame data may not have the branched sub-frame identification information and the second characteristic and the branched sub-frame main data are identified directly. For example, the resolution is 1920*1080, each frame includes six sub-frames regularly, the main data is transmitted via 24 data lines, one row synchronous data line and one column synchronous data line, three pixel points are transmitted in each clock cycle, and the first characteristic is a combination of the distance and the color, where the color is arranged in a fixed sequence of RGBRGB, and the distance information is transmitted via one data line. The six sub-frame main bodies of each frame main body are transmitted completely within 691200*6 clock cycles, and the distance information of the first characteristic corresponding to each sub-frame is transmitted completely within 16 clock cycles upon the transmission of each sub-frame main body. As frame and sub-frame data are all transmitted in a format agreed during the design of hardware and software in the example, there is no need to write the corresponding identification information specially.

Step 1008: generate the holographic image according to the file characteristic data, the frame characteristic data, the sub-frame characteristic data and the branched sub-frame characteristic data and output the holographic image. Similar to the step 1005, the file characteristic data and the frame characteristic data include the practical content or not include the practical content.

The sequence of the above steps is not limited, and it is allowable to change the sequence or delete some step according to an actual demand or a manner easily understood by the person skilled in the art.

In the step 1008, there may be various methods for processing the image element included in the branched sub-frame data according to the first characteristic and the second characteristic. Among them, one optional processing method includes the following steps:

1. Input a target image IpmX11(x, y) and an initial phase ΦpmXi(x, y), the number of iterations R, and the number of superimposed holographic sub-frames/branched sub-frames S, and initialize r=1, s=1.

2. Suppose target intensity and phase distribution.

$${T}_{s 1}^{p m X} ( x , y ) = \sqrt{{I}_{s 1}^{p m X} ( x , y )} {e}^{i {Φ}_{s}^{pmX} ( x , y )}$$

3. Calculate a quantized hologram H^{pmX}ₛᵣ (ξ,η)=Q{C(Trans{T^{pmX}ₛᵣ (x, y)},A_{ξη},P_{ξη},G_{ξη})}.

4. Determine r<R; if yes, run the step 5; and if no, skip to the step 8.

5. Calculate an image T′^{pmX}ₛᵣ=Trans⁻¹ {C⁻¹ (H^{pmX}ₛᵣ(ξ,η),A_{ξη},P_{ξη},G_{ξη})} generated by H^{pmX}ₛᵣ (ξ,η).

6. Suppose r=r+1.

7. Calculate T^{pmX}ₛᵣ=l(T^{pmX}ₛ₁,T^{pmX}ₛ₍ᵣ₋₁₎,T′^{pmX}ₛ₍ᵣ₋₁₎,A_{ξη},P_{ξη},G_{ξη}), and skip back the step 3.

8. Output a corresponding quantized hologram H^{pmX}ₛᵣ(ξ,η) of a corresponding frame/sub-frame/branched sub-frame.

9. Suppose s=s+1, reset the r, and suppose r=1.

10. Determine s≤S; if yes, run the step 11; and if no, end the calculation of the frame/sub-frame/branched sub-frame image, and wait for or accept a next frame/sub-frame image.

11. Suppose an energy distribution of the next sub-frame as I^{pmX}ₛ₁=k(T^{pmX}₁₁,T′^{pmX}_{1R},T′^{pmX}_{2R}, . . . , T′^{pmX}₍ₛ₋₁₎ᵣ₎, continue to use or generate a new Φ^{pmX}ᵢ(x,y), and skip back to the step 2.

The I^{pmX}₁₁(x,y) is image data of the input frame or sub-frame or branched sub-frame, the T^{PmX}ₛ₁(x,y) is an intensity distribution, and the Φ^{pmX}ᵢ(x,y) may be the phase obtained by iteration of a previous frame of image, and may also be pre-stored or obtained in other methods. The Trans{ } and the Trans⁻¹{ } are transformation and inverse transformation (for example, Fourier transformation, inverse Fourier transformation, Fresnel transformation, inverse Fresnel transformation and simulated annealing algorithm and etc.) to generate the hologram correspondingly, the A_{ξη} is illumination light intensity and phase distribution, the P_{ξη} is characteristic data, the G_{ξη} is optical compensation data and is configured to compensate aberration (spherical aberration, comatic aberration, astigmation, field curvature, distortion, higher order aberration, lateral chromatic aberration, color chromatic aberration, etc.) generated in an optical system and/or optical aberration (myopia, hyperopia, astigmatism, etc.) generated by human eyes, and the C( ), C⁻¹( ) is function and inverse function relationship for the intensity and phase distribution of the hologram and image generated after the addition of the compensation data. The Q{ } is a quantitative method (for example, abandonment intensity, quantization phase distribution, or intensity and phase synthesized by the use of a double-phase method, quantitative phase distribution, etc.), the l(T^{pmX}ₛ₁,T^{pmX}ₛ₍ᵣ₋₁₎,T′^{pmX}ₛ₍ᵣ₋₁₎,A_{ξη},P_{ξη},G_{ξη}) is the relevant operational method of target intensity and phase distribution T^{pmX}ₛ₁ concerning the frame or sub-frame or branched sub-frame, target intensity T^{pmX}ₛ₍ᵣ₋₁₎ for previous iteration, actual previous intensity and phase distribution T′^{pmX}ₛ₍ᵣ₋₁₎ and optical compensation data, imaging distance data and etc. The equation indicates I^{pmX}ₛ₁=k(T^{pmX}₁₁,T′^{pmX}_{1R},T^{′pmX}_{2R}, . . . ,T′^{pmX}_{(s-1)R}) indicates that the target energy distribution corresponding to each holographic branched sub-frame is associated with the previously generated holographic sub-frame/branched sub-frame (holographic sub-frame/branched sub-frame corresponding to a sub-frame or branched sub-frame of the corresponding data), and the k( ) is the corresponding function relationship.

The sequence of the above steps is not limited, and the sequence may be subjected to change or deletion according to an actual demand or a manner easily understood by the person skilled in the art.

In addition, the frame/sub-frame/branched sub-frame of the hologram may also not be completely in one-to-one correspondence with the frame/sub-frame/branched sub-frame of the image. Theoretically, a picture of hologram may include all information (including various imaging distances and angles, etc.) of a display image and the implementation in a manner of quickly overlapping multiple sub-frames or branched sub-frames in time turns out to be unnecessary. For example, 10 branched sub-frames in one sub-frame of the image respectively represent image elements at different imaging distances, so when the hologram is calculated, only one frame of hologram sub-frame (only having one branched sub-frame or no branched sub-frame) including 10 elements at different imaging distances may be generated, that is, one frame of hologram sub-frame (without 10 branched sub-frames) may include all characteristic information in the image elements in actual display. In the above example, the hologram sub-frame (only including one branched sub-frame) may be obtained via direct calculation; or 10 hologram sub-frames corresponding to images at different distances may be calculated first and are not output actually; and the 10 hologram sub-frames are processed (for example, in a manner of overlapping intensity and/or phase) into one hologram sub-frame (only including one frame of hologram sub-frame) and then output.

According to the method shown in FIG. 1 and the foregoing variation solution thereof, the image data structure shown in FIG. 2 or the foregoing variation solution thereof may be subjected to decapsulation and then processed to display. In addition, according to the method shown in FIG. 1 and the foregoing variation solution thereof, the image data of other structures including the image content may also reorganized in light of the image data structure shown in FIG. 2 and the foregoing variation solution to display.

With such an arrangement manner, the color, image distance and angle of each frame or sub-frame or branched sub-frame are recorded, and are recorded at a relatively uniform position to form a uniform criterion, thus improving the efficiency in extraction. On the other hand, image contents having similar characteristics may be recorded together, and displayed one by one according to a time sequence in display, thus improving the transmission efficiency, and reducing the switching frequency of a display device among different image distances and colors; and therefore, the requirement on hardware in display is low and the relatively good display effect is achieved.

In the above example, the difference of the frame, sub-frame and branched sub-frame for the viewer lies in: for the viewer, each frame is a picture of integral image seen at some moment (although a sub-frame image actually may be a quick switch in time, and makes the viewer consider that what he/he sees are different portions of a same picture of image but not multiple pictures of different images in time by means of persistence of vision of human eyes), and the sub-frame and the branched sub-frame are different characteristic elements in this image. Nevertheless, by virtue of superposition in a space at a same moment, and/or quick superposition at different moments (with the use of the persistence of vision of the human eyes), it is considered by the viewer that this is a frame of integral image.

It is to be noted that the above are merely the illustration for the optional example of the imaging method provided by the present invention. Many steps of the imaging method provided by the present invention may have various implementation manners, and will be further described below in some unrestricted examples.

According to one unrestricted example, the file characteristic data includes one or more of an image distance representing a position of an image element in imaging, a receiving object representing which user will receive, a viewing angle representing an angle formed between the image element and a viewer in imaging, a hidden-surface for a mutual blocking relationship of the image element in imaging, left and right frames representing which frame in the image data is sent to a left eye and which frame is sent to a right eye, an image color, and total light intensity of light when the image element images, and a scaling relationship representing a scaling relationship between the generated or recorded image element and the actual displayed image element.

Additionally, the image main data may be a bitmap, a vector diagram or a hologram needing to be displayed; and the bitmap, the vector diagram or the hologram may be encrypted or unencrypted, and may also be compressed or uncompressed.

According to one unrestricted example, the first characteristic is the color. In the step 1005, each frame main data is separated into multiple sub-frames, and the color of each image element in each sub-frame is one type in a spectrum. For example, when the RGB color space is used, each frame main data is separated into three sub-frames, where the color of the image element in the first sub-frame is red, the color of the image element in the second sub-frame is green, and the color of the image element in the third sub-frame is blue. In the current unrestricted example, the second characteristic is the image distance, that is, the distance between the image and the user in display. For example, in the step 1007, each frame main data is separated into three branched sub-frames; and the image distances of image elements in the three branched sub-frames are any distance in the space respectively, for example, the distances of three branched sub-frames of a first sub-frame in a first frame respectively are 0.5 m, 3 m and 20 m, the distances of three branched sub-frames of a second sub-frame of the first frame respectively are 0.8 m, 19 m and 5 m, the distances of three branched sub-frames of a third sub-frame of the first frame respectively are 0.5 m, 19 m and 30 m, the distances of three branched sub-frames of a first sub-frame of a second frame respectively are 0.1 m, 15 m and 8 m, the distances of three branched sub-frames of a second sub-frame of the second frame respectively are 0.1 m, 15 m and 8 m, and the distances of three branched sub-frames of a third sub-frame of the second frame respectively are 0.2 m, 8 m and 10 m, and so on. In this way, each piece of frame data is separated into 9 sub-frames. Three colors in the RGB may form various colors, and the different image distances may be respectively configured to display a near scenery, a medium-distance scenery and a distant scenery. Good display effect may be achieved by changing the distance freely.

According to another unrestricted example, the first characteristic is the image distance. For example, each frame file main data in the step 1005 is separated into multiple sub-frames, where the image distance of an image element in a first sub-frame is any distance in 0-1 m, the image distance of the image element in a second sub-frame is any distance in 1-5 m, and the image distance of the image element in a third sub-frame is any distance in 5-20 m to infinity. On the contrary, the second characteristic is the color. In the step 1007, each sub-frame main data is separated into three branched sub-frames, the color of the image element in each branched sub-frame uses 450 nm blue, 520 nm green and 638 nm red, and thus the color of each branched sub-frame is one of the three colors.

The color information is listed as characteristic information but not displayed ordinarily and arranged sequentially in a general fixed format such as RGB, which lies in that the holographic display often has some simple image display requirements on colors. For example, a set of device having an RGB full-color display function only has a white pattern for a long time in a video; in such a case, the original three sub-frame or branched sub-frame main data main of the RGB may be combined into one sub-frame or branched sub-frame main data, and only that an R color, a G color and a B color is labeled in the characteristic information describing the color of the main data; and in this way, the requirement on storage and transmission may be reduced. Furthermore, in some cases, it may also be appropriate to only calculate a hologram of one color (such as the G color); the hologram is directly or simply processed to output as the hologram for other colors (such as the R color and the B color); and under the irradiation of different light sources, a white image is synthesized; and therefore, the computation burden may further be reduced greatly.

Besides, as the holographic display uses interference and diffraction principles of the light for imaging, and the spatial light modulator has different diffraction angles for different optical wavelengths in fact, so in order to simplify the subsequent computation when the hologram is generated, or reduce the cost and design difficulty of optical hardware, the resolution of each color image may also be set to be different, and the resolution corresponding to each color sub-frame is written to the file characteristic data.

On the other hand, in the step 1003, the specific method for separating the whole image data into multiple pieces of frame data according to the frame identification information in the file characteristic data may be diverse, and will be further described below with some unrestricted examples.

According to one unrestricted example, the frame identification information in the file characteristic data includes frame length information representing a length of each piece of frame data. For example, the frame length information may be that “the length of each piece of frame data is 1 MB”. In the step 1003, the image main data in the image data may be separated at a length of 1 MB according to the frame length information to obtain the frame data. The same method may also be available to separate the frame data into the sub-frame data and separate the sub-frame data into the branched sub-frame data. The advantage lies in that each piece of frame, sub-frame and branched sub-frame data has a determined length and is processed easily. According to another unrestricted example, the frame identification information in the file characteristic data includes a special frame end field. For example, the frame identification information includes an “OXFF” frame end field. Meanwhile, an end of each piece of frame data has the frame end field in the image data. In the step 1003, the image data may be separated into multiple frames according to the frame end field. The method may also be applicable to the steps of separating the frame data into the sub-frame data and separating the sub-frame data into the branched sub-frame data.

In addition, the number of sub-frames and/or branched sub-frames and/or characteristic information in each piece of frame data may be changeable, for example, the first frame includes three sub-frames, the first sub-frame includes one branched sub-frame, the second sub-frame includes five branched sub-frames and the third sub-frame includes 20 branched sub-frames, the second frame includes five sub-frames, and the first sub-frame includes three branched sub-frames, etc. The relevant number of frames and the characteristic information may be written to the frame, sub-frame and branched sub-frame identification information.

The variation of the imaging method provided by the present invention in other aspects further includes: according to one unrestricted example, the step 1004 further includes: identify left-right frame information in the file image characteristic information. The left-right frame information represents that each piece of frame data in the image main data belongs to left frame data or right frame data. For example, the left-right frame information may be that “the odd number of frame data is the left frame data and the even number of frame data is the right frame data”. The identification of the left-right frame information can express the data to which each piece of frame data belongs. In the current example, the step 1007 correspondingly includes: project a branched sub-frame of a frame belonging to a left frame to a left eye of a user, and project the branched sub-frame of the frame belonging to a right frame to a right eye of the user. The left and right frame data often are data main bodies having a subtle difference, and correspond to subtle angular differences when the viewer views the scenery displayed in the frame. As the difference between the left and right frame data is very tiny usually, the left and right frames may also be recorded in a manner of a subordinated frame, for example, the left frame is a main frame, the right frame is a subordinated frame and what recorded is difference data with a left frame of image. Additionally, the left and right frames may further be separated into multiple left and right frame pairs, and different left and right frame pairs are respectively projected to multiple users located at different viewing angles. For example, the left and right frames are separated into three left and right frame pairs, the left and right frame pairs 1 are projected to the viewer located at −20°, the left and right frame pairs 2 are projected to the viewer located at 0°, and the left and right frame pairs 3 are projected to the viewer located at 10°.

According to one unrestricted example of the present invention, the data may further include multiple left and right frames at different angles, for example, three users are respectively located at viewing positions of −35°, 1° and 50°, the left-right frame information is further divided into left and right frames 1, left and right frames 2, and left and right frames 3, and after corresponding holograms are generated upon the completion of the processing of the processing module, the left and right frames 1, 2, 3 are respectively projected to the users located at different positions. The projection may be respectively sent via a server to terminal devices 1, 2, 3 worn by the three users after a relevant hologram is generated, so that the clients can see different angles of the image; and furthermore, when the users move, the angle at which each user views the image also changes in real time via the received change in angle and distance parameter. With such a protection, all frames (frames 1, 2, 3) are displayed on a set of special holographic display device, and the image at the three angles are respectively guided to eyes of the three users. The server can be connected to the client via a wireless or wired manner. Optionally, the wireless connection is one or more of Bluetooth, Wi-Fi, 3G, 4G and 5G.

According to one unrestricted example of the present invention, the frame characteristic data further includes compensation information to compensate the displayed image. Correspondingly, the step 1003 further includes: identify compensation information in the file characteristic data. The compensation information includes one or more of a spherical aberration coefficient, a comatic aberration coefficient, an astigmatic coefficient, a distortion coefficient, a field curvature coefficient, a lateral chromatic aberration, a position aberration, a higher order aberration, a diopter coefficient and an astigmatic coefficient. The compensation information may be, for example, generated according to the imaging device and user information associated with a condition of the user. Furthermore, the compensation information may also be generated jointly according to multiple pieces of information.

According to one unrestricted example, the method for processing the image main data, the frame main data and the sub-frame main data may be carried out by the use of operation associated with phase distribution. The specific method is to first convert the file characteristic data, the frame characteristic data or the sub-frame characteristic data into a corresponding phase distribution matrix, and use the phase distribution matrix when the image main data, the frame main data and the sub-frame main data are processed.

It is to be noted that the phase data may be the characteristic data such as the image distance and angle, may also be the compensation information such as one or more of a user short sightedness condition (diopter, astigmatism, etc.), aberration of an optical system and screen size, or may further be a combination of the characteristic data and the compensation information. The phase data may also be generated according to the above data. The characteristic data is associated with the display content and thus changes from time to time. The compensation information is mainly associated with a relatively fixed factor such as a play scenario, a play device and a viewer, and thus keeps unchanged basically in the whole imaging process. The characteristic data and the compensation information may be compensated after the hologram, kinoform or vector diagram is generated by using the main data and the final hologram, kinoform or vector diagram obtained by the calculation with the characteristic data and the compensation information is output to display, and the relevant characteristic data and the compensation information may also be generated into a phase matrix and calculated together with the main data, and the final hologram, kinoform or vector diagram is generated directly. The method for converting the characteristic data and/or the compensation information into the phase distribution matrix may use a Zernike polynomial or a Seidel polynomial.

The method for processing the image main data, the frame main data and the sub-frame image data by using the phase distribution of the characteristic data and/or the compensation information may be to load the phase distribution to the image main data, the frame main data and the sub-frame main data, and output the integrated image data, frame data, sub-frame data or branched sub-frame data. The loading method is to convert the phase distribution matrix obtained in the foregoing step into a size identical to a matrix of the image main data, and then perform four fundamental operations of corresponding points on the image data or a matrix of a corresponding hologram thereof and the phase distribution matrix. For example, the corresponding points are subjected to the same addition, subtraction, multiplication and division. The combined matrix is transmitted to the spatial light modulator, so that the expected image may be displayed. Specifically, the addition, subtraction, multiplication and division on the corresponding points are determined by a specific condition.

According to one unrestricted example, what recorded as the characteristic information and/or the compensation information in the corresponding characteristic data of the frame/sub-frame/branched sub-frame is the corresponding phase distribution information. For example, the phase distribution corresponding to the distance information is recorded in first characteristic information of the sub-frame as the characteristic information, so when the hologram is generated to display, the phase distribution is used to directly operate with the hologram and the generation of corresponding phase information turns out to be unnecessary; and therefore, the computation burden is reduced, and the system power consumption is lowered.

Similarly, an example of compensation will be used to describe how to process the characteristic data into the main data to generate the hologram.

The H^{pmR}_{ξη} is an uncompensated frame/sub-frame/branched sub-frame of the hologram, and the hologram which is compensated and added with the characteristic information is H′^{pmR}_{ξη}=C(H^{pmR}_{ξη},A_{ξη},P_{ξη},G_{ξη}), where the A_{ξη} is illumination light intensity and phase distribution, the G_{ξη}=g(ξ,η,x′,y′,θ) is the compensation information, the ξ,η is a corresponding frequency domain coordinate on the spatial light modulator and the x′, y′ is the size of a stop in an optical system. The C( ) is a mapping or inverse mapping relationship for intensity and phase distribution of the hologram after the compensated data is generated, and is determined by the adopted specific algorithm and processing capacity of hardware. Alternatively, G_{ξη}=g(ξ,η, x′, y′, θ, D, a, e₁, e₂,e₃, . . . ), where the D is a degree for short sightedness or far sightedness of the viewer, the a is an astigmatic degree, the e₁,e₂,e₃, . . . are other optical aberration coefficients such as a defocusing coefficient, a spherical aberration coefficient, a comatic aberration coefficient, an astigmatic coefficient, a distortion coefficient, a field curvature coefficient, a lateral chromatic aberration, a position aberration, a higher order aberration, a diopter coefficient and an astigmatic coefficient, and the g( ) is a functional relationship. The P_{ξη}=(ξ,η,d,θ) is intensity and/or phase distribution corresponding to the characteristic information, the d is an imaging distance, the θ is a viewing angle, the f( ) is a corresponding mapping relationship, and the g( ), f( ) may be different mapping relationships according to different algorithms or optical systems.

According to one unrestricted example, all or a part of compensation information and/or all or a part of characteristic information and phase distribution thereof may further be directly output to the spatial light modulator, and the corresponding main data and the other part of compensation information and/or characteristic information may be output to another display device (such as an OLED, an LCoS and a DMD screen). The advantage lies in that the main data displayed on the other display device may not be subjected to the calculation of the hologram and thus the operation is simplified; and in some cases, the better display effect may be achieved.

According to one unrestricted example, the frame data/sub-frame/branched sub-frame characteristic data further includes angle information, so that the image element may be optimized for the viewer at different angles. For example, the step 1004 further includes: identify information representing a mapping angle of the frame in the frame characteristic data. The mapping angle may be a combination of one or more of any angles. In the step 1007, the sub-frame/branched sub-frame data belonging to the same frame data is rotated first according to the angle information of the frame data, and the rotated branched sub-frame data is used for displaying. Similar to the compensation, the rotating step may also be implemented in various manners.

According to one unrestricted example, the frame/sub-frame/branched sub-frame characteristic data further includes surface-hidden information, so that the image element can correctly embody a fore-and-aft relationship in the space. For example, a frame of image includes two sub-frames, the main body data of a sub-frame 1 includes a square and is located at a 2 m place of the viewer, and the main data of a sub-frame 2 is a non-transparent triangle and is located at a 1 m place of the viewer; and in actual display, the bottom right corner of the square located on a rear side is shielded by the triangle located on a front side and cannot be seen, and the pixel coordinate of a shielded portion of the square is recorded according to an angle in the hidden relationship in the sub-frame 1; and when the hologram is generated actually, the image for this portion of the sub-frame 1 is removed, and is no longer displayed in final output. Correspondingly, the step 1004 further includes: identify hidden information corresponding to the frame data in the characteristic data. In the step 1007, the main data belonging to the same frame/sub-frame/branched sub-frame data are processed according to the hidden information of the frame/sub-frame/branched sub-frame, the shielded portion is removed, and the frame/sub-frame/branched sub-frame data after removing the shielded portion is used for processing to display.

In addition, according to one unrestricted example, the file characteristic data further includes other relevant information. The relevant information may include: one or more of the image data length information, the compensation information, temperature information, brightness information, bit depth information, resolution information, play speed information, single frame data format information, frame characteristic data length information, whether to compress and a compression manner, creation time information and encryption manner information. In output, the output data may be adjusted according to the information. The temperature information may record a service temperature of the device in work, so that a temperature control system (if any) in the system controls a working temperature of the device within an appropriate range.

According to one unrestricted example, the sub-frame characteristic data further includes light intensity information, and the content in the sub-frame main data is distribution of image light intensity. When the sub-frame is displayed, the light intensity information read from the sub-frame characteristic data is sent to a light source or a light source drive, and the hologram generated by the sub-frame main data is sent to the spatial light modulator. Such an arrangement lies in: for the modulated light intensity and phase distribution of the hologram, the light energy is guided to a required place via interference and diffraction principles in imaging, and the undesired light is not shielded like a common display technology does for imaging; all light intensities are gathered to a displayed image content by the spatial light modulator (that is, for the hologram, there is no difference between the image all having the gray scale of 1 and the image all having the gray scale of 255), and it is necessary to adjust total output of the light source to adjust total brightness; and in this sense, the light intensity information is required to be written to the sub-frame characteristic data.

According to one unrestricted example, the main data of the frame/sub-frame/branched sub-frame is the vector diagram, for example, the main data of one branched sub-frame records vertex coordinates of 100 triangles and filled texture information thereof. In actual processing, the vector diagram is calculated first to generate a corresponding bit map and then the hologram is generated. The advantage lies in that the vector diagram is not distorted for any zooming and angle rotating; and when the vector diagram is corresponding to different characteristic information, the better display quality can be achieved. Alternatively, it may also be appropriate to first generate holograms corresponding to 100 triangles and then operate all relevant holograms (for example, accumulated holograms in the frequency domain) to obtain a final output image.

According to one unrestricted example, the main data of the frame/sub-frame/branched sub-frame is the hologram, for example, the main data of one branched sub-frame records the hologram of a flower vase. In actual processing, only the characteristic information and/or compensation information are operated with the existing hologram, for example, the imaging distance of the flower vase is adjusted to 1 m according to the characteristic information, the angle is adjusted to 10° with the center and the size is scaled to be 95% of the original size. The recalculation for generating the hologram of a target image turns out to be unnecessary, only the calculation of the characteristic information or compensation information is carried out, the computation burden may be greatly reduced, the efficiency is improved, and the power consumption is reduced.

According to one unrestricted example, at least one part of frame data included in the image data is the subordinated frame. The subordinated frame only records difference information with the previous frame. The difference information may be the frame/sub-frame/branched sub-frame main data, and/or the characteristic information. In display, the combination of the branched sub-frame data of the previous frame and the difference information and the branched sub-frame data as a current frame are displayed. If multiple continuous frames are the subordinated frames, the branched sub-frame finally displayed by the previous frame is taken as the previous frame to combine with the difference information included in the current frame, and then the combined branched sub-frame is displayed. Therefore, the size of the image data may be small, and the transmission bandwidth is saved. Additionally, for some images with a small difference, the hologram corresponding to the previous frame/sub-frame/branched sub-frame may be directly processed to obtain the hologram needing to be displayed by this frame, and thus the computation burden is reduced.

According to one unrestricted example, a part or all of the foregoing steps 1002-1008 may be operated at the server to further reduce the load of local hardware. Specifically, after the image data needing to be displayed is generated at the client, the image data may be sent to the server first. Furthermore, the client further sends a play scenario parameter such as display size, a display distance, a viewing angle, environmental light intensity information and other information to the server. The server may execute the tasks of the steps 1002-1008 according to the information. Upon the completion of the tasks, the server processes the frame/sub-frame/branched sub-frame data according to the play scenario parameter and sends the processed sub-frame/branched sub-frame of the hologram directly used for displaying to the client. Optionally, when the hologram corresponding to a last piece of frame data is displayed completely, the determination on whether subsequent input is present is made; and in case of no subsequent input, the hologram corresponding to the last piece of frame data is displayed continuously.

Certainly, the client may also send the file characteristic data and/or frame characteristic data to the server (the characteristic data may be obtained via a sensor of the client, such as a camera, a Global Positioning System (GPS), a light intensity sensor, a gyroscope and an accelerometer), so that the server processes the image main data and/or frame main data according to the file characteristic data and/or frame characteristic data. Alternatively, in other unrestricted examples, the client may send instruction information requiring the server to generate the image data to the server; and after the image data is processed by the server, it is sent back to the client to display. Additionally, the server may receive relevant data or instruction from multiple clients, and may also send the relevant data or instruction to more than one client.

Optionally, the client further sends the play scenario parameter to the server when sending an image file to the server. The play scenario parameter includes one or more of display size, a distance between an image of a display and a user, resolution, a viewing angle, a scaling, environmental light intensity, image surface-hidden information and color information. The server optimizes the sub-frame data or branched sub-frame data according to the play scenario parameter, and sends the optimized hologram generated by the sub-frame or branched sub-frame data to the client.

The specific method for displaying the frame/sub-frame/branched sub-frame data may be diverse, for example, one optional method is to cache a certain number of sub-frame/branched sub-frame data first and then output the data to the spatial light modulator in a color cyclic arrangement manner. For example, a sequence of a red branched sub-frame, a green branched sub-frame, a blue branched sub-frame and a next red branched sub-frame is used to display in an RGB color space so as to achieve the better color combination effect. It may also be appropriate that the branched sub-frames of three colors in the RGB are respectively and simultaneously output to three spatial light modulators, and the required colors are output and displayed simultaneously via a color combination light path.

In order to solve at least one part of the technical problem of the present invention, the present invention further provides an imaging apparatus for a holographic image. The apparatus includes a memory and a processor. The memory may be a hard disk, a flash memory, an internal memory, etc.; and the processor may be a universal processor (such as a Central Processing Unit (CPU) and a Graphic Processing Unit (GPU)), and may also be an Application Specific Integrated Circuit (ASIC) or a Field Programmable Gate Array (FPGA), etc. The memory stores a computer code; and the processor executes, when running the computer code stored on the memory, the imaging method for the holographic image mentioned above. It may also be appropriate to develop the imaging method for the holographic image into hardware via the ASIC; and therefore, the memory does not need to store the computer code in some cases.

Furthermore, in order to solve at least one part of the technical problem of the present invention, the present invention further provides a computer readable medium storing a computer code thereon. The readable medium may be an optical disc, a hard disk, a flash memory, etc. The computer code stored on the computer readable medium is configured to execute, when a processor runs the code, the above-mentioned imaging method for the holographic image.

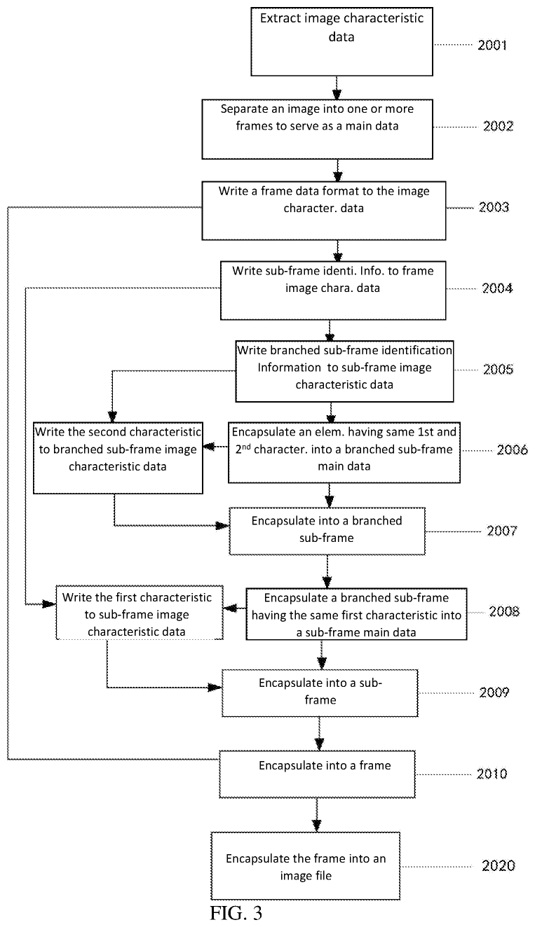

In order to solve at least one part of the technical problem of the present invention, the present invention further provides a dynamic data generation method for a holographic image, which will be described below with reference to FIG. 3. The data generation method for the holographic image provided by the present invention includes the following steps: Step 2001: extract a characteristic of an image element needing to be displayed, and take the extracted characteristic as a file characteristic data, the characteristic including one or more of an image distance, a receiving object, a viewing angle, a scaling, left and right frames, hidden information, a color, and light intensity.

Step 2002: separate the characteristic extracted image element into one or more frames according to a time sequence, and take the one or more frames as an image main data.

Step 2003: write frame identification information corresponding to a frame data format of to-be-generated frame data to file characteristic data. The method and objective for separating all elements needing to be displayed according to time are approximately identical to the method and objective for separating a common planar video into frames. The objective of writing the frame identification information corresponding to the frame data format of the to-be-generated frame data to the file characteristic data is to correspond each frame made in a subsequent step to the identification information in this step. The file characteristic data is completed in advance, so that the whole image data is transmitted in a manner of streaming media. In addition, the information (for example, the data format) in the frame identification information may also be agreed in advance during the design of hardware and/or software and does not need to be written to the frame identification information specially. In this sense, the step 2003 may be omitted. For example, the resolution of the image is 1024*1024, the main data is transmitted via eight data lines, one row synchronous data line and one column synchronous data line, one pixel is transmitted in each clock cycle, the characteristic is a combination of a distance and an angle, and the distance and the angle are respectively transmitted via one independent data line. Each frame main data is transmitted completely within 1024*1024 clock cycles, and the distance and angle information of the characteristic corresponding to each frame is transmitted completely within 24 clock cycles upon the transmission of each frame main data. As the frame data are all transmitted in a format agreed during the design of hardware and software in the example, there is no need to write the frame identification information specially, and thus the step 2003 may be omitted.

It is to be noted that the step 2020 of arranging one or more pieces of frame data into the image main data according to the time sequence, and encapsulating the image main data and the file characteristic data into the image data may be directly executed after this step in some examples. However, in the current example, the method is skipped to the step 2004 upon the completion of this step.

Step 2004: write sub-frame identification information corresponding to a sub-frame data format of to-be-generated sub-frame data to frame characteristic data. In addition, the sub-frame identification information may also be agreed in advance, so that the step 2004 is omitted like the step 2003.

Step 2005: write branched sub-frame identification information corresponding to a branched sub-frame data format of to-be-generated branched sub-frame data to sub-frame characteristic data. In addition, the branched sub-frame identification information may also be agreed in advance, so that the step 2005 is omitted like the steps 2003 and 2004.

Step 2006: take the image element having same first characteristic and second characteristic in each frame as a branched sub-frame main data of same branched sub-frame data, and write the second characteristic to the branched sub-frame characteristic data, the second characteristic being a combination of one or more of the color, the image distance, the receiving object, the scaling, the viewing angle, the light intensity, the hidden information and the left and right frames, and the first characteristic being another combination of one or more of the color, the image distance, the receiving object, the scaling, the viewing angle, the light intensity, the hidden information and the left and right frames. The meanings of the color, the image distance, the viewing angle and the like are no longer repeated herein. The significance of this step lies in that the required image and corresponding characteristic parameters thereof can be encapsulated according to a uniform data format, and thus the image element having the same characteristic can be processed and displayed once for all or in sequence.

Step 2007: encapsulate the branched sub-frame main data and corresponding branched sub-frame characteristic data into one piece of branched sub-frame data.

Step 2008: take the branched sub-frame having the same first characteristic in each frame as a sub-frame main data, and write the first characteristic to the sub-frame characteristic data, the first characteristic being one or more of the color, the image distance, the receiving object, the scaling, the viewing angle, the left and right frames, a hidden relationship and the light intensity and different from the second characteristic.

Step 2009: encapsulate the sub-frame main data and corresponding sub-frame characteristic data into one piece of sub-frame data.

Step 2010: take sub-frame data in each frame as a frame main data, and encapsulate the frame main data and the frame characteristic data into the frame data.

Certainly, the level of the branched sub-frame may also be omitted, and the element having the same first characteristic is directly encapsulated into the sub-frame main data. According to the above content, the method is not conceived difficultly and thus will not be repeated thereto.

Further, the image generation method may also be predefined on a hardware device, such as a length of each frame, and a specific parameter represented by the first characteristic of the sub-frame. In this way, there is no need to generate the header data. A data stream of a to-be-displayed content and a data stream of corresponding characteristic information are generated directly according to an agreed format on the device in actual application, and transmitted to a processing module to be processed to output and display.

The specific implementation device for the above steps may also be diverse, for example, the file characteristic data may be modulated on the spatial light modulator together with the image main data, and the image main data may also be modulated on other chips (such as OLED, LCoS or DMD). Furthermore, the sequence of the above steps is not fixed, and it is allowable to change the sequence or delete a relevant step according to a manner easily known by the person skilled in the art.

According to the method shown in FIG. 3, the image data including a dynamic image content may be converted into a dynamic image data structure shown in FIG. 2.

It is to be noted that the above example is merely the illustration of the optional example for the generation of the image data provided by the present invention. Many steps for the generation of the image data provided by the present invention may have various implementation manners:

First of all, similar to the imaging method, the first characteristic may be the color, the image distance, the receiving object, the scaling, the left and right frames, the hidden information, the light intensity or the viewing angle. The corresponding second characteristic may be the image distance, the receiving object, the scaling, the left and right frames, the hidden information, the light intensity, the viewing angle or the color.

Next, similar to the imaging method, the frame identification information may be the frame length information, and may also be the frame end field; and this is also a similar case for the sub-frame identification information and the branched sub-frame identification information.

Moreover, according to one unrestricted example, when the image data is generated, a left frame image element needing to be projected to a left eye of the user and a right frame image element needing to be projected to a right eye of the user may be identified first in the image element. Herein, the “identification” should have a generalized understanding, that is, the calculation of a same element as the left frame image element and the right frame image element should also be understood as the “identification” of the left frame image element and the right frame image element. Therefore, it may be appropriate to write the left frame image element to left frame data and write the right frame image element to right frame data, so that the left frame image element is finally projected to the left eye of the user, and the right frame image element is finally projected to the right eye of the user. Meanwhile, the left-right frame information on whether each piece of frame data is the left frame data or the right frame data is written to the file characteristic data, so that whether each piece of frame data is the left frame data or the right frame data may be identified in imaging. Optionally, the left frame data and the right frame data may be the same in number and arranged alternately, and the relevant information may be agreed in advance and does not need to be written to the file characteristic data.

According to one unrestricted example, when the dynamic image data is generated, each frame of compensation information may be generated according to hardware and/or a viewer of the device. The compensation information may include one or more of a spherical aberration coefficient, a comatic aberration coefficient, an astigmatic coefficient, a distortion coefficient, a field curvature coefficient, a lateral chromatic aberration, a position aberration and a higher order aberration. The compensation information may further include a degree of short sightedness/far sightedness, a degree of astigmatism and the like of glasses of the viewer. After the compensation information is generated, the compensation information is written to the corresponding file characteristic data. The compensation information may be generated according to information of a play device, and may also be generated according to a play scenario parameter or generated according to the viewer. Furthermore, a part of compensation information may also not be integrated into the image data, and is input dynamically at each time of play, for example, as the degree of short sightedness for eyes of each viewer may be different, the image data does not record the compensation information associated with the degree of short sightedness of the viewer but relevant compensation information generated according to input information of the viewer at each time of play.

According to one unrestricted example, when the dynamic image data is generated, each frame of angle information may also be generated according to a dynamic image needing to be displayed. The angle information represents a mapping angle formed when the frame is projected. Each frame of angle information is written to characteristic information of corresponding frame data so as to be read when the frame is displayed. The selection on the mapping angle may be diverse. One optional manner is that all mapping angles may be adjusted freely in real time and may be any angle in a space.

According to one unrestricted example, when the dynamic image data is generated, other relevant information of the dynamic image needing to be displayed may further be written to the file characteristic data. The relevant information may be one or more of the image data length information, temperature information, depth information, resolution information, play speed information, single frame data format information, bit depth information, play speed information, frame characteristic data length information, creation time information, whether to compress and how to compress, and whether to encrypt and an encryption manner information, so that the information is available in play.

According to one unrestricted example, when the dynamic image data is generated, it may further be appropriate to take total light intensity of a frame/sub-frame/branched sub-frame main data in each frame/sub-frame/branched sub-frame data as light intensity information to write to image characteristic data of the frame/sub-frame/branched sub-frame data, and normalize the frame/sub-frame/branched sub-frame main data to serve as the frame/sub-frame/branched sub-frame main data, so that there is no need to calculate the total light intensity or additionally obtain the total light intensity information in display.

According to one unrestricted example, when the dynamic image data is generated, it may further be appropriate to take at least one frame/sub-frame/branched sub-frame as a subordinated frame/sub-frame/branched sub-frame, and take difference information between the frame/sub-frame/branched sub-frame and a previous frame/sub-frame/branched sub-frame of the frame/sub-frame/branched sub-frame as a content of the frame/sub-frame/branched sub-frame data. Therefore, the size of the image data may be small, and the transmission bandwidth is saved.

According to one unrestricted example, when the dynamic image data is generated, it may further be appropriate that a vector diagram of an image needing to be displayed is taken as the image main data to store in a first frame and multiple frames/sub-frames/branched sub-frames thereafter do not store the image main data but only change the characteristic information such as the viewing angle and the distance. The processing module generates a frame/sub-frame/branched sub-frame of the hologram according to the image main data and the characteristic information of the multiple frames/sub-frames/branched sub-frames and outputs the frame/sub-frame/branched sub-frame to display. Therefore, the size of the image data may be small, and the transmission bandwidth is saved.

In order to solve at least one part of the technical problem of the present invention, the present invention further provides an image data generation apparatus. The apparatus includes a processor, and may also include a memory. The memory may be a hard disk, a flash memory, an internal memory, etc.; and the processor may be a universal processor and may also be an FPGA, etc. The memory stores a code; and the processor executes, when running the code stored on the memory, the dynamic data generation method for the holographic image mentioned above.

Furthermore, in order to solve at least one part of the technical problem of the present invention, the present invention further provides a computer readable medium storing a code thereon. The readable medium may be an optical disc, a hard disk, a flash memory, etc. The code stored on the computer readable medium is configured to enable a processor, when running the code, the above-mentioned dynamic data generation method for the holographic image.

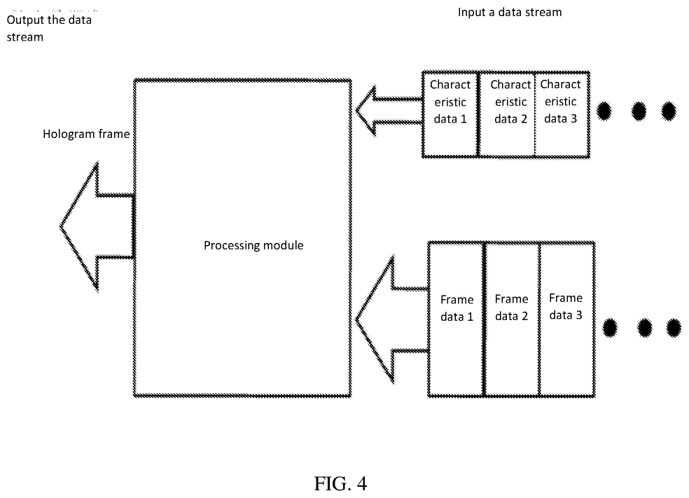

In order to solve at least one part of the technical problem of the present invention, the present invention further provides an imaging apparatus for an image. The apparatus includes a processor (such as an FPGA, or a customized and developed ASIC chip), and specially implements the above-mentioned imaging method for the holographic image via a hardware manner. The apparatus will be described below with an unrestricted example. FIG. 4 illustrates a single-color holographic display device. In the current example, the characteristic data is an image distance. In the current example, the processing module is the FPGA. Characteristic information and branched sub-frame data are respectively input to the processing module by the use of different pins, and are synchronized in input time. For example, when the input sub-frame data is 1, pins for inputting distance data maintains to transmit a special voltage level (representing the distance 1). The processing module combines the distance 1 and the sub-frame data 1 according to the method described in the present invention to generate a corresponding hologram or kinoform and output the hologram or kinoform. When the processing modules finish receiving the sub-frame data 1 and then starts to receive sub-frame data 2, the level on pins for receiving the distance information is to transmit data representing the distance 2, and so on.

The display device in the above example may be head-mounted Augmented Reality (AR) glasses, the image main data comes from own software or a connected external device thereof (such as a mobile phone, a personal computer and a telecommunication sever), the characteristic data may be from an own sensor device (such as data obtained by a camera via the analysis of a SLAM method, and data of a laser distance meter, a gyroscope, an accelerometer, a light intensity sensor and other sensors) or from a connected external device thereof (the mobile phone, the personal computer and the telecommunication sever). The processing module may be built in the glasses, generates a corresponding hologram in real time according to the received data, and outputs and displays images having different imaging distances. For example, a first frame of image respectively labels two objects at 0.5 m and 3 m towards a viewer, and the frame/sub-frame of a corresponding hologram displays corresponding images at 0.5 m and 3 m, and objects corresponding to a second frame of image are two objects at 0.55 m and 4 m, and the frame/sub-frame of a corresponding second hologram displays corresponding images at 0.55 m and 4 m. It is to be noted that the processing module may also be located on an external device (such as the server, the mobile phone and the personal computer) to reduce the size of the AR glasses and lower the power consumption.

Although the present invention has been described with reference to the current specific embodiments, it should be appreciated by the person of ordinary skill in the art that the above embodiments are merely for describing the present invention, and various equivalent changes or replacements or deletions may further be made without departing from the spirit of the present invention. Therefore, any change and variation of the above embodiments within a substantial spiritual scope of the present invention will fall within the scope of the claims of the present invention.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. An imaging method for an image, comprising the following steps:
step 1: receiving image data, the image data comprising an image main data and image characteristic data; and
step 10: processing the image main data according to the image characteristic data, generating the holographic image and outputting the holographic image.

2. The imaging method according to claim 1, wherein the image characteristic data comprises file characteristic data, frame characteristic data and sub-frame characteristic data, and the imaging method further comprises the following steps:
step 2: identifying the image main data or the file characteristic data and the image main data comprised in the image data;
step 3: separating the image main data into one or more pieces of frame data;
step 4: reading the frame data, and identifying a frame main data or the frame main data and the frame characteristic data of the frame data;
step 5: separating the frame main data into one or more pieces of sub-frame data, reading each piece of sub-frame data, identifying a sub-frame main data and sub-frame characteristic data of the sub-frame data, the sub-frame characteristic data comprising a first characteristic, and each image element in the sub-frame main data having the same first characteristic, and extracting the first characteristic; and
step 6: processing the sub-frame main data according to the file characteristic data, the frame characteristic data and the sub-frame characteristic data, generating the holographic image and outputting the holographic image, the file characteristic data and the frame characteristic data comprising a practical content or not comprising the practical content.

3. The imaging method according to claim 2, wherein the step 6 further comprises the following steps:
step 6.1: reading each piece of sub-frame data, and identifying a sub-frame characteristic data and a sub-frame main data for each piece of sub-frame data;
step 6.2: separating the sub-frame main data into one or more pieces of branched sub-frame data, reading each piece of branched sub-frame data, identifying a branched sub-frame main data and branched sub-frame characteristic data of the branched sub-frame data, each image element in the branched sub-frame data having a same second characteristic; and
step 6.3: generating the holographic image according to the file characteristic data, the frame characteristic data, the sub-frame characteristic data and the branched sub-frame characteristic data and outputting the holographic image.

4. The imaging method according to claim 1, wherein the image characteristic data comprises one or more of an image distance, a receiving object, a viewing angle, a scaling factor, a hidden-surface, left and right frames, an image color and intensity.

5. The imaging method according to claim 1, wherein the image main data is a bitmap, a vector diagram or a hologram needing to be displayed; and the bitmap, the vector diagram or the hologram are encrypted or unencrypted, and compressed or uncompressed.

6. he imaging method according to claim 3, wherein the first characteristic is the color, each frame main data is separated into multiple pieces of sub-frame data, and the color of each image element in the sub-frame data is one in the spectrum; or
the second characteristic is the color, each sub-frame main data is separated into multiple pieces of branched sub-frame data, and the color of each image element in the branched sub-frame data is one in the spectrum.

7. The imaging method according to claim 2, wherein the file characteristic data comprises frame identification information, the frame identification information comprises frame length information representing a length of each piece of frame data, and the image data is separated into multiple pieces of frame data according to the frame length information in the step 3; and/or
the frame characteristic data comprises sub-frame identification information, the sub-frame identification information comprises sub-frame length information representing a length of each sub-frame, and each frame main data is separated into one or more pieces of sub-frame data according to the sub-frame length information in the step 5.

8. The imaging method according to claim 7, wherein the sub-frame characteristic data comprises branched sub-frame identification information, the branched sub-frame identification information comprises branched sub-frame length information representing a length of each branched sub-frame, and each sub-frame main data is separated into one or more pieces of branched sub-frame data according to the branched sub-frame length information in the step 6.1.

9. The imaging method according to claim 2, wherein the file characteristic data comprises frame identification information, the frame identification information comprises a frame end field, an end of each piece of frame data has the frame end field, and the image data is separated into one or more pieces of frame data according to the frame end field in the step 3; and/or
the frame characteristic data comprises sub-frame identification information, the sub-frame identification information comprises a sub-frame end field, an end of each sub-frame has the sub-frame end field, and each frame main data is separated into one or more pieces of sub-frame data according to the sub-frame end field in the step 5.

10. The imaging method according to claim 9, wherein the sub-frame characteristic data comprises branched sub-frame identification information, the branched sub-frame identification information comprises a branched sub-frame end field, an end of each branched sub-frame has the branched sub-frame end field, and each sub-frame main data is separated into multiple pieces of branched sub-frame data according to the branched sub-frame end field in the step 6.1.

11. The imaging method according to claim 2, further comprising the following steps:
step 3.1: identifying that the file characteristic data further comprises left-right frame information, the left-right frame information representing that the frame data in the image main data belongs to left frame data or right frame data; and
step 10.1: projecting a sub-frame or a branched sub-frame of a frame belonging to a corresponding left frame to a left eye of a user, and projecting the sub-frame or the branched sub-frame of the frame belonging to a right frame to a right eye of the user.

12. The imaging method according to claim 2, wherein the method for processing the image main data and/or the frame main data and/or the sub-frame main data is to generate corresponding phase distribution according to the file characteristic data and/or the frame characteristic data and/or the sub-frame characteristic data.

13. The imaging method according to claim 12, wherein the phase distribution is loaded to the image main data and/or the frame main data and/or the sub-frame main data and/or the branched sub-frame main data, and the integrated image data and/or frame data and/or sub-frame data and/or branched sub-frame data are output.

14. The imaging method according to claim 13, further comprising the following step:
step 3.2: identifying compensation information in the image data, the compensation information comprising one or more of a defocusing coefficient, a spherical aberration coefficient, a comatic aberration coefficient, an astigmatic coefficient, a distortion coefficient, a field curvature coefficient, a lateral chromatic aberration, a position aberration, a higher order aberration, a diopter coefficient and an astigmatic coefficient.

15. The imaging method according to claim 2, further comprising the following steps:
step 3.3: identifying angle information in the frame characteristic data; and
step 6.3: rotating frame or sub-frame or branched sub-frame data belonging to same frame data according to an angle corresponding to the angle information in the frame characteristic data, and outputting the rotated frame or sub-frame or branched sub-frame data.

16. The imaging method according to claim 2, further comprising the following steps:
step 3.4: identifying relevant information comprised in the file characteristic data, the relevant information comprising one or more of the image data length information, the compensation information, temperature information, brightness information, bit depth information, resolution information, play speed information, single frame data format information, frame characteristic data length information, a compression manner, creation time information and encryption manner information; and
step 6.4: adjusting the sub-frame or branched sub-frame data according to the relevant information.

17. The imaging method according to any one of claim 2, further comprising the following steps:
step 6.5: reading light intensity information in frame data or sub-frame characteristic data characteristic data; and
when displaying the frame data or the sub-frame data, sending the light intensity information to a light source drive or a light source, and sending a hologram generated after the processing of the frame or sub-frame main data to a spatial light modulator.

18. The imaging method according to any one of claim 1, wherein at least one part of the characteristic data is directly converted into the phase distribution to output to the spatial light modulator.

19. The imaging method according to any one of claim 1, wherein
the image data at least comprises a piece of subordinated frame, and the subordinated frame data only comprises difference information between the subordinated frame data and a previous piece of frame data of the subordinated frame data; and
when displaying the subordinated frame data, taking a combination of frame data of the previous piece of frame data and frame data of the subordinated frame data as the subordinated frame data.

20. The imaging method according to claim 1, wherein the step 1 and/or the step 10 are completed at a server, and the server sends a result to one or more clients.

21. The imaging method according to claim 2, wherein at least one step in the steps 1-6 is completed at the server, and the server sends the result to one or more clients.

22. The imaging method according to claim 21, wherein the client sends at least one part of the file characteristic data and/or the frame characteristic data to the server; and/or
the client sends instruction information requiring the server to generate the image data to the server.

23. The imaging method according to claim 2, wherein at least one step in the steps 1-6 is completed at the client, and the rest are completed at the server; and
the server sends the result to one or more clients.

24. The imaging method according to claim 23, further comprising the following step:
step 1.1: sending, by the client, a video file and/or a play scenario parameter to the server; and
step 6.5: optimizing, by the server, the frame data or the sub-frame data or the branched sub-frame data according to the play scenario parameter, and sending an optimized hologram generated by the frame data or the sub-frame data or the branched sub-frame data to the client, the play scenario parameter comprising one or more of display size, resolution, a distance between an image and a user, a viewing angle, environment light intensity, surface-hidden information, color information, the compensation information, the scaling, the receiving object, and the left and right frames.

25. The imaging method according to any one of claim 20, wherein the server is connected to the client via a wireless or wired manner.

26. (canceled)

27. The imaging method according to any one of claim 1, wherein upon the determination that a last piece of frame data of the image data is displayed completely and no subsequent input is provided, the current frame data is displayed cyclically.

28. The imaging method according to claim 2, wherein the holographic image output by the step 6 is cached and then output to the spatial light modulator in a color cyclic arrangement manner.

29. The imaging method according to claim 2, wherein the method for processing the image main data, or processing the image main data and the image characteristic data comprises the following steps:
step a: inputting energy distribution of a target image, the preset superimposed number of holographic sub-frames and a preset iteration condition, or the energy distribution of the target image, the preset superimposed number of holographic sub-frames and the preset iteration condition as well as at least one of an imaging distance, an imaging angle and the compensation information;
step b: calculating intensity and phase distribution of a frame/sub-frame/branched sub-frame image needing to be displayed;
step c: calculating a hologram frame or a hologram sub-frame or a hologram branched sub-frame;
step d: determining whether the iteration condition is met; if yes, operating the step e;
and if no, skipping to the step g;
step e: calculating a quantized hologram frame or a quantized hologram sub-frame or a quantized hologram branched sub-frame;
step f: calculating new intensity and phase distribution according to an image corresponding to the quantized hologram frame or the quantized hologram sub-frame or the quantized hologram branched sub-frame and/or intensity and/or phase distribution and/or compensation information of a frame/sub-frame/branched sub-frame image needing to be displayed, and skipping back to the step c, or changing the iteration condition or parameter and skipping back to the step c;
step g: outputting a corresponding quantized hologram frame/sub-frame/branched sub-frame of a corresponding frame/sub-frame/branched sub-frame;
step h: supposing to accumulate the superimposed number of hologram sub-frames/branched sub-frames, and resetting the iteration condition;
step i: determining whether the superimposed number of hologram sub-frames/branched sub-frames reaches to a preset value; if no, operating the step j; and if yes, ending the calculation of the frame or sub-frame image, and waiting for or accepting a next frame or sub-frame image; and
step j: changing the intensity and/or phase distribution or corresponding parameter of the frame/sub-frame/branched sub-frame image, and skipping to the step b.

30. An image data generation method, comprising the following steps:
step 101: extracting a characteristic of an image element needing to be displayed, and taking the extracted characteristic as image characteristic data, the characteristic comprising one or more of an image distance, a receiving object, a scaling, a viewing angle, left and right frames, surface-hidden information, a color, and light intensity;
step 102: separating the characteristic extracted image element into one or more frames according to a time sequence, and taking the one or more frames as an image main data; and
step 130: encapsulating the image main data and the image characteristic data into image data.

31. The image data generation method according to claim 30, further comprising the following step:
step 103: writing frame identification information corresponding to a frame data format of to-be-generated frame data to the image characteristic data.

32. The image data generation method according to claim 30,
wherein the image characteristic data comprises file characteristic data, frame characteristic data and sub-frame characteristic data, and the image main data and the file characteristic data are encapsulated into the image data in the step 102;
the image data generation method further comprises the following steps:
step 104: taking the image element having a same first characteristic in each frame as a sub-frame main data of one sub-frame data, and writing the first characteristic to the sub-frame characteristic data, the first characteristic being one or more of the color, the image distance, the receiving object, the viewing angle, the scaling, the left and right frames, a surface-hidden relationship and the light intensity; and
step 105: taking sub-frame data in each frame as a frame main data, and encapsulating the frame main data and the frame characteristic data into frame data; and
the file characteristic data and the frame characteristic data comprise a practical content or not comprise the practical content.

33. The image data generation method according to claim 32, further comprising the following step:
step 106: writing sub-frame identification information corresponding to a sub-frame data format of to-be-generated sub-frame data to the frame characteristic data.

34. The image data generation method according to claim 32, wherein the image characteristic data further comprises branched sub-frame characteristic data, and the image data generation method further comprises the following steps:
step 106: taking the image element having a same second characteristic as a branched sub-frame main data, and writing the second characteristic to the branched sub-frame characteristic data, the second characteristic being one or more of the color, the image distance, the receiving object, the viewing angle, the scaling, the left and right frames, the surface-hidden relationship and the light intensity;
step 107: encapsulating the branched sub-frame main data and corresponding branched sub-frame characteristic data into one piece of branched sub-frame data;
step 120: taking branched sub-frames having the same first characteristic in each frame as a sub-frame main data, and encapsulating the sub-frame main data and corresponding sub-frame characteristic data into one piece of sub-frame data; and
step 121: taking sub-frame data in each frame as a frame main data, and encapsulating the frame main data and the frame characteristic data into the frame data.

35. The image data generation method according to claim 34, further comprising the following step:
step 108: writing branched sub-frame identification information corresponding to a branched sub-frame data format of to-be-generated sub-frame data to the sub-frame characteristic data, and/or writing sub-frame identification information corresponding to a sub-frame data format of to-be-generated sub-frame data to the frame characteristic data.

36. The image data generation method according to claim 35, wherein at least one of the file characteristic data, the frame characteristic data, the sub-frame characteristic data and the branched sub-frame characteristic data is phase distribution.

37. The image data generation method according to claim 32, wherein a method for converting the file characteristic data, the frame characteristic data, the sub-frame characteristic data or the branched sub-frame characteristic data into the phase distribution is to calculate the phase distribution for the current image characteristic data, frame characteristic data, sub-frame characteristic data or branched sub-frame characteristic data, or invoke the corresponding phase distribution in a preset phase distribution library according to the file characteristic data, the frame characteristic data, the sub-frame characteristic data or the branched sub-frame characteristic data.

38. The image data generation method according to claim 34, wherein the first characteristic is the color, the color of the sub-frame data is written to the sub-frame characteristic data in the step 104, and the color of the image element in the sub-frame data is one of basic parameters in a color space; or
the second characteristic is the color, the same color is written to branched sub-frame characteristic data of the branched sub-frame in the step 104, and the color of each image element in the branched sub-frame data is one of the basic parameters in the color space.

39. The image data generation method according to claim 34, wherein the first characteristic is the image distance, the image distance of the sub-frame data is written to the sub-frame characteristic data in the step 104, and the image distance of each image element in the sub-frame data is the same; or
the second characteristic is the image distance, the same image distance is written to branched sub-frame characteristic data of the branched sub-frame in the step 106, and the image distance of each image element in the branched sub-frame data is the same.

40. The image data generation method according to claim 35, wherein the frame identification information, the sub-frame identification information or the branched sub-frame identification information is a length of the frame data, the sub-frame data or the branched sub-frame data.

41. The image data generation method according to claim 35, wherein the frame identification information, the sub-frame identification information or the branched sub-frame identification information is a frame end field on the end of the frame data, a sub-frame end field on the end of the sub-frame data or a branched sub-frame field on the end of the branched sub-frame data.

42. The image data generation method according to claim 32, further comprising the following step:
identifying a left frame image element needing to be projected to a left eye of a user and a right frame image element needing to be projected to a right eye of the user, writing the left frame image element to left frame data, writing the right frame image to right frame data, and writing left-right frame information on whether each piece of frame data is the left frame data or the right frame data to the file characteristic data.

43. The image data generation method according to claim 42, wherein the left frame data and the right frame data are the same in number and are arranged alternately in the image data.

44. The image data generation method according to claim 30, further comprising the following steps: generating compensation information according to device and/or user information, the compensation information comprising one or more of a spherical aberration coefficient, a comatic aberration coefficient, an astigmatic coefficient, a distortion coefficient, a field curvature coefficient, a lateral chromatic aberration, a position aberration, a higher order aberration, a diopter coefficient and an astigmatic coefficient; and writing the compensation information to the file characteristic data.

45. The image data generation method according to claim 30, further comprising the following step:
generating angle information for each frame according to an image needing to be displayed, and writing the angle information for each frame to frame characteristic data of corresponding frame data.

46. The image data generation method according to claim 32, wherein relevant information of the image needing to be displayed is written to the file characteristic data, the relevant information comprising one or more of the image data length information, the compensation information, temperature information, brightness information, bit depth information, resolution information, play speed information, single frame data format information, frame characteristic data length information, whether to compress and a compression manner, creation time information and encryption manner information.

47. The image data generation method according to claim 30, further comprising the following step:
taking total light intensity of a branched sub-frame main data in each piece of branched sub-frame data as light intensity information to write to branched sub-frame characteristic data of the branched sub-frame data, and normalizing the branched sub-frame main data to serve as the branched sub-frame main data; or
taking total light intensity of a sub-frame main data in each piece of sub-frame data as light intensity information to write to sub-frame characteristic data of the sub-frame data, and normalizing the sub-frame main data to serve as the sub-frame main data; or
taking total light intensity of a frame main data in each piece of frame data as light intensity information to write to frame characteristic data of the frame data, and normalizing the frame main data to serve as the frame main data.

48. The image data generation method according to claim 34, further comprising the following step:
taking at least one unit as a subordinated unit, and taking a difference between the subordinated unit and a previous unit of the subordinated unit as a content of the subordinated unit, wherein the unit is the frame data, the sub-frame data, or the branched sub-frame data.

49. An apparatus, comprising a processor, wherein the processor enables, when running, the apparatus to at least execute a method, comprising the following steps:
step 1: receiving image data, the image data comprising an image main data and image characteristic data; and
step 10: processing the image main data according to the image characteristic data, generating the holographic image and outputting the holographic image.

50. The apparatus of claim 49, further comprising a memory, wherein the memory comprises a computer code stored thereon, and the code is configured to enable, when being run on the processor, the apparatus to execute the method.

51. (canceled)

52. The imaging method according to claim 2, wherein the image data at least comprises a piece of subordinated frame/sub-frame, and the subordinated frame/sub-frame data only comprises difference information between the subordinated frame/sub-frame data and a previous piece of frame/sub-frame data of the subordinated frame/sub-frame data; and
when displaying the subordinated frame/sub-frame data, taking a combination of frame/sub-frame data of the previous piece of frame/sub-frame data and frame/sub-frame data of the subordinated frame/sub-frame data as the subordinated frame/sub-frame data.

53. The imaging method according to claim 21, wherein the server is connected to the client via a wireless or wired manner.

54. The imaging method according to claim 22, wherein the server is connected to the client via a wireless or wired manner.

55. An apparatus, comprising a processor, wherein the processor enables, when running, the apparatus to at least execute a method, comprising the following steps:
step 101: extracting a characteristic of an image element needing to be displayed, and taking the extracted characteristic as image characteristic data, the characteristic comprising one or more of an image distance, a receiving object, a scaling, a viewing angle, left and right frames, surface-hidden information, a color, and light intensity;
step 102: separating the characteristic extracted image element into one or more frames according to a time sequence, and taking the one or more frames as an image main data; and
step 130: encapsulating the image main data and the image characteristic data into image data.

56. The apparatus of claim 55, further comprising a memory, wherein the memory comprises a computer code stored thereon, and the code is configured to enable, when being run on the processor, the apparatus to execute the method.
